(19) United States
(12) Patent Application Publication
(10) Pub. No.: US 2014/0365806 A1
(43) Pub. Date: Dec. 11, 2014

(54) PERIPHERAL APPARATUS AND CONTROL METHOD THEREOF

(71) Applicant: Cal-Comp Electronics & Communications Company Limited, New Taipei City (TW)

(72) Inventors: Yung-Hsiang Tsai, New Taipei City (TW); Po-An Lai, New Taipei City (TW); Hwai-Chih Lee, New Taipei City (TW)

(73) Assignee: Cal-Comp Electronics & Communications Company Limited, New Taipei City (TW)

(21) Appl. No.: 13/951,444

(22) Filed: Jul. 25, 2013

(30) Foreign Application Priority Data
Jun. 7, 2013 (TW) 102120366

(51) Int. Cl. G06F 1/28

(52) U.S. Cl. CPC G06F 1/28
USPC 713/340

(57) ABSTRACT

A peripheral apparatus and a control method thereof are provided. The peripheral apparatus is suitable for coupling an electronic device to provide a peripheral function to the electronic device for use, where the peripheral apparatus draws power supplies from the electronic device. The peripheral apparatus includes a power detecting module and a control unit. The power detecting module detects a voltage drop characteristic of a system voltage provided by the electronic device and generates a voltage detecting signal accordingly, where the voltage detecting signal is related to a magnitude of an average output current of the electronic device. The control unit is coupled to the power detecting module and controls an operation state of the peripheral apparatus according to the voltage detecting signal, such that the peripheral apparatus is operated in at least one of a first, a second and a third operation states which are different from each other.

### CROSS-REFERENCE TO RELATED APPLICATION

This application claims the priority benefit of Taiwan application serial no. 102120366, filed on Jun. 7, 2013. The entirety of the above-mentioned patent application is hereby incorporated by reference herein and made a part of this specification.

### BACKGROUND

1. Technical Field

The invention relates to a peripheral apparatus and a control method thereof. Particularly, the invention relates to a peripheral apparatus and a control method thereof capable of detecting a current output capability of an electronic device to accordingly adjust an operation state.

2. Related Art

Along with development of technology, various peripheral apparatuses such as portable hard drives or external optical drives, etc., are continually developed. A user can use peripheral functions provided by the peripheral apparatus through an electronic device such as a desktop computer or a notebook computer, etc., so as to expand performance of the electronic device and improve usage convenience. Generally, the peripheral apparatus can be connected with the computer through a universal serial bus (USB) or other bus interfaces, so that the user can use the functions of the peripheral apparatus through the electronic device and draw the required power supply.

In the present technique, the power supplies provided by different bus interfaces respectively have a limitation in specification. Taking the USB interface as an example, a rated system voltage provided by the electronic device through the USB interface is about 5V, and a rated output current is about 500 mA.

However, in an actual application, the power supply (or an actual current output capability) actually provided by the electronic device can be different according to a hardware configuration of the electronic device. For example, when a plurality of USB connection ports of the electronic device are connected to the peripheral apparatuses, the rated output current of the electronic device are allocated to the multiple USB connection ports, such that the current actually received by each of the peripheral apparatuses is lower than the rated output current. Now, if a higher current is required to drive a load of the peripheral apparatus, the peripheral apparatus probably cannot operate. In this case, the user cannot learn a reason why the peripheral apparatus cannot operate.

### SUMMARY

The invention is directed to a peripheral apparatus and a control method thereof, which is capable of detecting a current output capability of an electronic device to accordingly adjust an operation state.

The invention provides a peripheral apparatus, which is suitable for coupling an electronic device to provide a peripheral function to the electronic device for use, where the peripheral apparatus draws power supplies required for operation from the electronic device. The peripheral apparatus includes a power detecting module and a control unit. The power detecting module detects a voltage drop characteristic of a system voltage provided by the electronic device and generates a voltage detecting signal accordingly, where the voltage detecting signal is related to a magnitude of an average output current of the electronic device. The control unit is coupled to the power detecting module and controls an operation state of the peripheral apparatus according to the voltage detecting signal, such that the peripheral apparatus is operated in at least one of a first, a second and a third operation states that are different from each other.

The invention provides a control method of a peripheral apparatus including following steps. A voltage drop characteristic of a system voltage provided by an electronic device is detected. A voltage detecting signal is generated according to the voltage drop characteristic of the system voltage, where the voltage detecting signal is related to a magnitude of an average output current of the electronic device. An operation state of the peripheral apparatus is controlled according to the voltage detecting signal, such that the peripheral apparatus is operated in at least one of a first, a second and a third operation states that are different from each other.

According to the above descriptions, according to the peripheral apparatus and the control method thereof, the peripheral apparatus can detect the voltage drop characteristic of the system voltage provided by the electronic device to determine the magnitude of the average output current (i.e. a current output capability), and the peripheral apparatus can be operated in different operation states according to the current output capability, such that the peripheral apparatus has better power specification compatibility.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a structural schematic diagram of a peripheral apparatus according to an embodiment of the invention.

FIG. 2 is a schematic diagram of a relative relationship of power supplies and operation states according to an embodiment of the invention.

FIG. 3A is a structural schematic diagram of a power detecting module according to an embodiment of the invention.

FIG. 3B is an operation schematic diagram of the power detecting module of FIG. 3A.

FIG. 4A is a structural schematic diagram of a power detecting module according to another embodiment of the invention.

FIG. 4B is an operation schematic diagram of the power detecting module of the embodiment of FIG. 4A.

FIG. 5 is a flowchart illustrating a control method of a peripheral apparatus according to an embodiment of the invention.

FIG. 6 is a flowchart illustrating a control method of a peripheral apparatus according to another embodiment of the invention.

### DETAILED DESCRIPTION OF DISCLOSED EMBODIMENTS

An embodiment of the invention provides a peripheral apparatus and a control method thereof. The peripheral apparatus can detect a voltage drop characteristic of a system voltage provided by an electronic device to determine a magnitude of an average output current (i.e. a current output capability) of the electronic device, and the peripheral apparatus operates in different operation states according to the current output capability, such that the peripheral apparatus has better power specification compatibility. In order to fully convey the content of the invention, embodiments are provided below to describe the invention in detail. Wherever possible, the same reference numbers are used in the drawings and the description to refer to the same or like parts.

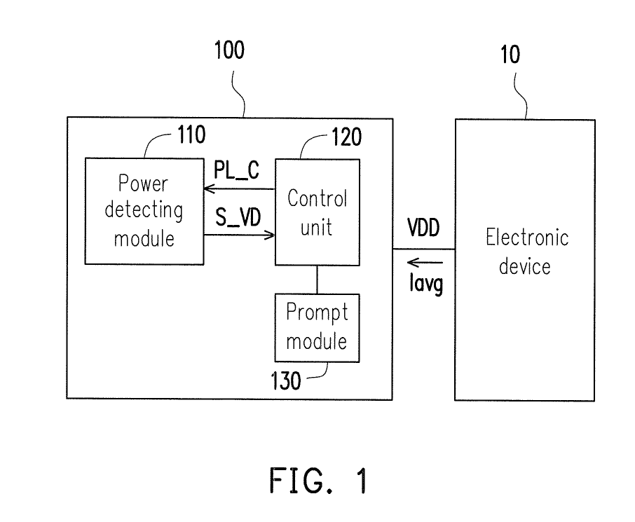

FIG. 1 is a structural schematic diagram of a peripheral apparatus according to an embodiment of the invention. In the present embodiment, an electronic device 10 is, for example, a notebook computer, an ultra-thin notebook, a tablet PC, a desktop computer or a smart phone, etc. that has an independent power supply. The peripheral apparatus 100 is, for example, a portable hard drive, an external optical drive or a card reader, etc. that is capable of providing a corresponding peripheral function (for example, data accessing or optical disc reading/writing, etc.). The peripheral apparatus 100 is coupled to the electronic device 10 through a bus interface, and performs data transmission and data exchange with the electronic device 10 through the bus interface, so as to provide the peripheral function to the electronic device 10 for use. The bus interface is, for example, a universal serial bus interface of various specifications (for example, USB 2.0, USB 3.0, mini USB, micro USB, etc.) or a mobile high-definition link (MHL) interface, etc. that is capable of transmitting power, so that when the peripheral apparatus 10 is connected to the electronic device 10, the peripheral apparatus 100 draws a power supply required for operation from the electronic device 10.

Referring to FIG. 1, the peripheral apparatus 100 includes a power detecting module 110 and a control unit 120. The power detecting module 110 detects a voltage drop characteristic of a system voltage VDD provided by the electronic device 10 and generates a voltage detecting signal S_VD accordingly, where the voltage detecting signal S_VD is related to a magnitude of an average output current Iavg of the electronic device 10 (i.e. an average of currents output by the electronic device 10 during a certain period). The control unit 120 is coupled to the power detecting module 110 and controls an operation state of the peripheral apparatus 100 according to the voltage detecting signal S_VD, such that the peripheral apparatus 100 selectively operates in at least three different operation states according to the magnitude of the average output current Iavg of the electronic device 10. In other words, the peripheral apparatus 100 is controlled to operate in at least one of a first, a second and a third operation state that are different from each other.

In detail, the peripheral apparatus 100 may have a corresponding function module (not shown) according to the provided peripheral function. For example, if the peripheral apparatus 100 is a portable hard drive, the function module thereof is a memory module, and if the peripheral apparatus 100 is an external optical drive, the function module thereof is an optical read/write module, and so on. The control unit 120 can control an operation of the function module according to an instruction received from the electronic device 10, so as to provide the peripheral function to the electronic device 10 for use. In the present embodiment, the control unit 120 can adjust the operation state of the peripheral apparatus 100 by controlling a ratio of disable/enable periods of the function module in operation timing, so as to correspondingly control a working efficiency of the peripheral apparatus 100. When the control unit 110 determines that the current output capability of the electronic device 10 is relatively low, the control unit 110 controls the peripheral apparatus 100 to operate in a lower working efficiency. Conversely, when the control unit 110 determines that the current output capability of the electronic device 10 is relatively high, the control unit 110 controls the peripheral apparatus 100 to operate in a higher working efficiency.

Therefore, even if the electronic device 10 has a lower current output capability due to hardware configuration (for example, the electronic device 10 is simultaneously connected to a plurality of peripheral apparatuses) or other reasons, as long as the average output current Iavg of the electronic device 10 is higher than a lower limit current required for operating the peripheral apparatus 100, the peripheral apparatus 100 can continually operate by decreasing the working efficiency, so as to avoid being turned off due to insufficient power supply.

Further, in the present embodiment, the control unit 120 can control the power detecting module 110 to activate a detection mechanism for detecting the voltage drop characteristic of the system voltage VDD at a predetermined operation time point, such that the control unit 120 determines the magnitude of the average output current Iavg (i.e. a magnitude of the current output capability, and the greater that average output current Iavg is, the stronger the current output capability is) provided by the electronic device 10, so as to determine the operation state of the peripheral apparatus 100.

For example, in an exemplary embodiment, the control unit 120 can control the power detecting module 110 to activate the detection mechanism when the peripheral apparatus 100 is connected to the electronic device 100, and before the peripheral apparatus 100 starts to provide the peripheral function, the control unit 120 first determines a corresponding operation state according to the voltage detecting signal S_VD (a detailed method that the peripheral apparatus 100 adjusts the operation state is described below in other embodiment).

In another exemplary embodiment, the control unit 120 can control the power detecting module 110 to activate the detection mechanism in a specific period during the operation of the peripheral apparatus 100, such that the control unit 120 periodically determines whether to adjust the operation state of the peripheral apparatus 100.

In still another exemplary embodiment, the control unit 120 further detects whether another peripheral apparatus is connected to the electronic device 10, and when the control unit 120 detects that the other peripheral apparatus is connected to the electronic device 10, the control unit 120 controls the power detecting module 110 to activate the detection mechanism to determine whether or not to adjust the operation state of the peripheral apparatus 100.

According to the aforementioned exemplary embodiments, those skilled in the art should understand that the peripheral apparatus 100 can activate the detection mechanism at any operation time point in case that the peripheral apparatus 100 is connected to the electronic device 10, so as to adjust the operation state of the peripheral apparatus 100. In other words, a timing of activating the detection mechanism can be designed by a designer according to an actual design requirement, which is not limited by the invention.

Moreover, in an exemplary embodiment, the peripheral apparatus 100 may further include a prompt module 130. The prompt module 130 is coupled to the control unit 120, and sends a corresponding prompt message according to the operation state of the peripheral apparatus 100. For example, the prompt message is, for example, a corresponding light or sound (though invention is not limited thereto) varied along with different operation states of the peripheral apparatus 100, so as to prompt the user the current operation state of the peripheral apparatus 100.

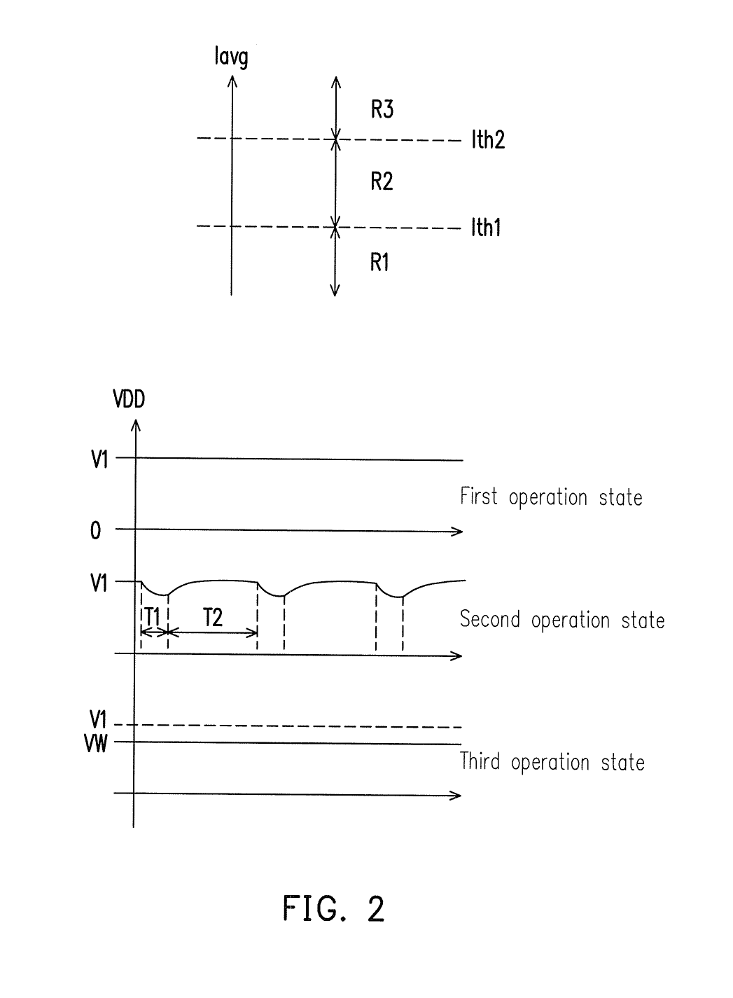

In order to clearly describe the embodiment of the invention, FIG. 2 is a schematic diagram of a relative relationship of power supplies and operation states according to an embodiment of the invention. Referring to FIG. 1 and FIG. 2, in the present embodiment, the designer can set at least two different threshold values Ith1 and Ith2 according to an actual design requirement, so as to define at least three different current ranges R1-R3. The control unit 120 determines one of the current ranges R1-R3 where the average output current Iavg falls in according to the voltage detecting signal S_VD, and accordingly adjusts the operation state of the peripheral apparatus 100.

In detail, if the control unit 120 determines that the average output current Iavg falls in the current range R1 (i.e. the average output current Iavg is smaller than the threshold value Ith1) according to the voltage detecting signal S_VD, the control unit 120 controls the peripheral apparatus 100 to operate in the first operation state. Under such operation state, the control unit 120 determines that the current output capability of the electronic device 10 is excessively low and stops the operation of the peripheral apparatus 100. Now, since the peripheral apparatus 100 does not operate, the system voltage VDD is maintained to a predetermined voltage value V1 without producing a voltage drop.

On the other hand, if the control unit 120 determines that the average output current Iavg falls in the current range R2 (i.e. the average output current Iavg is greater than or equal to the threshold value Ith1 and is smaller than the threshold value Ith2) according to the voltage detecting signal S_VD, the control unit 120 controls the peripheral apparatus 100 to operate in the second operation state. Under such operation state, the control unit 120 determines that the current output capability of the electronic device 10 is slightly lower, though the current output capability is still enough to drive the peripheral apparatus 100 to operate in a lower working efficiency. Therefore, the control unit 120 controls the peripheral apparatus 100 to normally operate during a working period T1, and controls the peripheral apparatus 100 to stop operating during a suspension period T2, so as to provide the peripheral function through an intermittent operation mode. Under the second operation state, although the whole working efficiency of the peripheral apparatus 100 is decreased due to the intermittent operation mode, the system voltage VDD can be charged during the suspension period T2, so that the system voltage VDD is recovered back to the predetermined voltage value V1 before entering the working period T1 for the next time. Therefore, the system voltage VDD can still be maintained above a certain voltage value to maintain the peripheral apparatus 100 to a workable state.

Moreover, if the control unit 120 determines that the average output current Iavg falls in the current range R3 (i.e. the average output current Iavg is greater than the threshold value Ith2) according to the voltage detecting signal S_VD, the control unit 120 controls the peripheral apparatus 100 to operate in the third operation state. Under such operation state, the control unit 120 determines that the current output capability of the electronic device 10 is enough to drive the peripheral apparatus 100 to normally operate. Therefore, the system voltage VDD drops from the initial voltage value V1 to a working voltage value VW slightly lower than the voltage value V1, and is maintained to the working voltage value VW. Here, the working efficiency of the peripheral apparatus 100 operated under the third operation state is higher than that of the peripheral apparatus 100 operated under the second operation state.

It should be noticed that in the present embodiment, the designer can define more than three current ranges according to an actual design requirement, such that the peripheral apparatus 100 can correspondingly operate in more than three operation states, though the invention is not limited thereto.

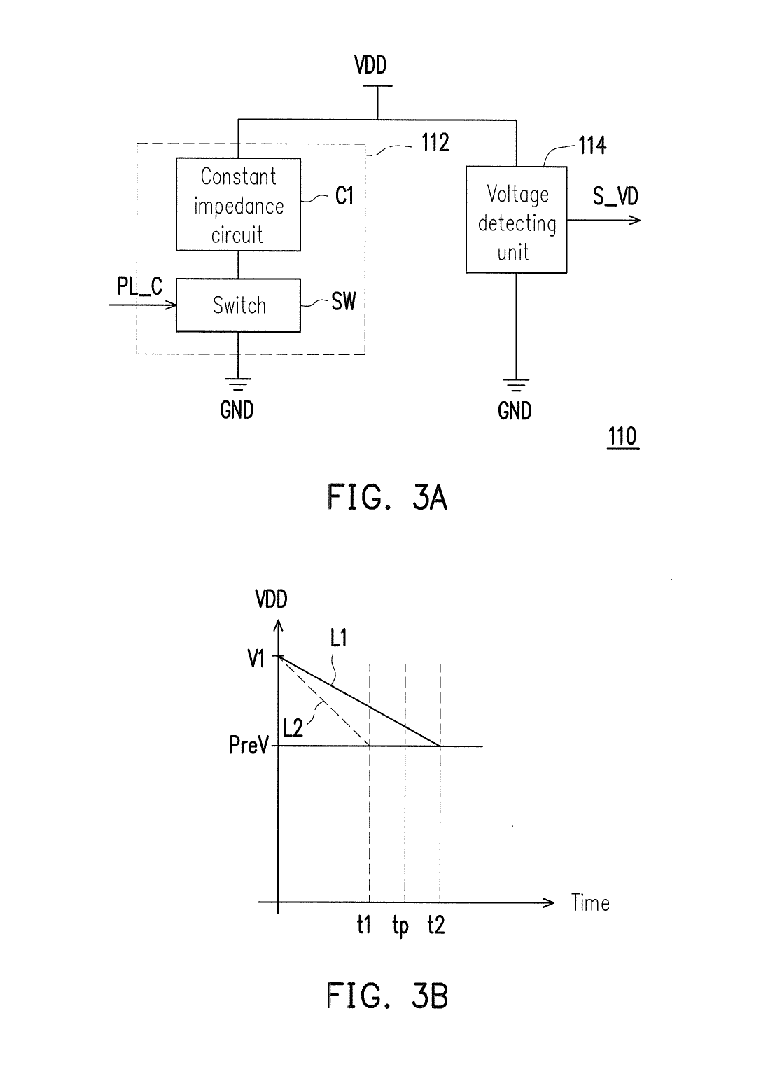

FIG. 3A is a structural schematic diagram of a power detecting module according to an embodiment of the invention. Referring to FIG. 1 and FIG. 3A, the power detecting module 110 includes a pre-loading unit 112 and a voltage detecting unit 114. The pre-loading unit 112 can be used to provide a current path coupled to the system voltage VDD, where the pre-loading unit 112 is controlled by the control unit 120 to determine whether or not to turn on the current path, such that the system voltage VDD may have a voltage drop in response to the turned-on current path. The voltage detecting unit 114 is coupled to the pre-loading unit 112, and detects the system voltage VDD to determine a voltage drop characteristic of the system voltage VDD according to a relative relationship between time and the voltage drop generated by the system voltage VDD based on the turned-on current path, so as to generate the voltage detecting signal S_VD accordingly. In the present embodiment, the voltage detecting unit 114 can be implemented by any circuit having a voltage detecting function.

In the present embodiment, the pre-loading unit 112 can be implemented by a constant impedance circuit C1 and a switch SW, where the constant impedance circuit C1 is, for example, an electronic component having a constant impedance such as a resistor or a transistor, etc. The switch SW is turned on or turned off under control of a control signal PL_C of the control unit 120, so as to determine whether or not to turn on the current path. The current path refers to a path from the system voltage VDD to a ground terminal GND through the constant impedance circuit C1 and the switch SW.

In detail, when the detection mechanism of the power detecting module 110 is activated, the control unit 120 sends the corresponding control signal PL_C to turn on the switch SW of the pre-loading unit 112, such that the electronic device 10 outputs a current though the current path of the pre-loading unit 112. Now, if the current output capability of the electronic device 10 is insufficient, the system voltage VDD quickly drops during a period when the switch SW is turned on. Conversely, if the current output capability of the electronic device 10 is enough to drive the peripheral apparatus 100 to normally operate, the system voltage VDD only drops slightly and gradually. Based on such voltage drop characteristic, the voltage detecting unit 114 can determine the current output capability of the electronic device 10, and accordingly generate the corresponding voltage detecting signal S_VD.

FIG. 3B is an operation schematic diagram of the power detecting module of FIG. 3A, in which line segments L1 and L2 respectively represent a relative relationship between the system voltage VDD and time under different current output capability of the electronic device 10.

Referring to FIGS. 3A and 3B, when the detection mechanism of the power detecting module 110 is activated, the power detecting unit 114 calculates a voltage drop time (for example, t1 and t2) required when the system voltage VDD drops from the voltage value V1 to a voltage value PreV, and compares the voltage drop time with a predetermined time tp. When the voltage drop characteristic of the system voltage VDD corresponds to the line segment L1, the voltage detecting unit 114 determines that the voltage drop time t2 required when the system voltage VDD drops from the voltage value V1 to the voltage value PreV is higher than the predetermined time tp, and accordingly outputs the corresponding voltage detecting signal S_VD. Now, the control unit 120 determines that the electronic device 10 has a higher average output current/current output capability according to the voltage detecting signal S_VD. Conversely, when the voltage drop characteristic of the system voltage VDD corresponds to the line segment L2, the voltage detecting unit 114 determines that the voltage drop time t1 is lower than the predetermined time tp, and accordingly outputs the corresponding voltage detecting signal S_VD. Now, the control unit 120 determines that the electronic device 10 has a lower average output current/current output capability according to the voltage detecting signal S_VD. In other words, in the present embodiment, the voltage detecting unit 114 indicates the voltage drop characteristic of the system voltage VDD by the voltage drop time, and accordingly generates the voltage detecting signal S_VD, where the voltage drop time is proportional to the average output current/current output capability of the electronic device 10.

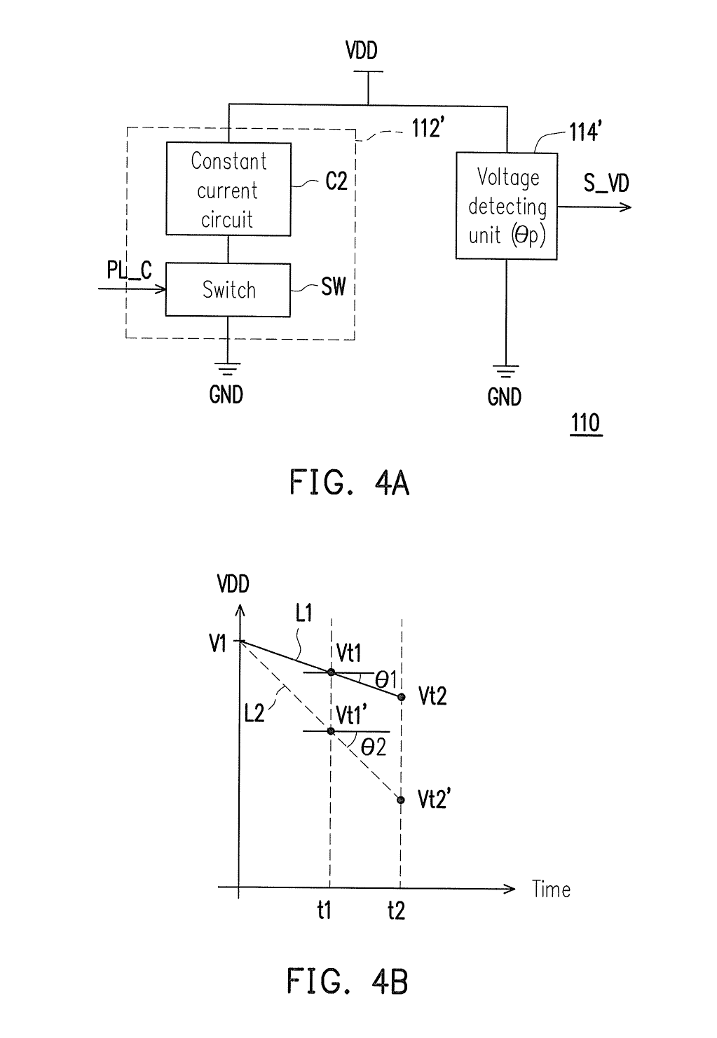

FIG. 4A is a structural schematic diagram of a power detecting module according to another embodiment of the invention. The structure of the power detecting module 110 is approximately the same to that of the power detecting module 110 of the embodiment of FIG. 3A, and a difference there between is only that the pre-loading unit 112′ is implemented by a constant current circuit C2 and the switch SW, so that descriptions of the parts that are the same or similar to the embodiment of FIG. 3A are not repeated, and only the difference between the detection mechanisms of the present embodiment and the aforementioned embodiment is further described.

FIG. 4B is an operation schematic diagram of the power detecting module of the embodiment of FIG. 4A, in which a solid line and a dot line respectively represent a relative relationship between the system voltage VDD and time under different current output capability of the electronic device 10.

Referring to FIG. 4A and FIG. 4B, when the detection mechanism of the power detecting module 110 is activated, the power detecting unit 114′ respectively extracts voltage values (Vt1 and Vt2 on the line segment L1, and Vt1′ and Vt2′ on the line segment L2) of the system voltage VDD at time points t1 and t2, and accordingly calculates a voltage variation rate of the system voltage VDD during a predetermined period (a period from the time point t1 to the time point t2), where the voltage variation rates is represented by included angles θ1 and θ2 between voltage-time curves and a horizontal line (which can also be represented by a slope).

The voltage detecting unit 114′ compares the detected voltage variation rate with a predetermined voltage variation rate (θp). When the voltage drop characteristic of the system voltage VDD corresponds to the line segment L1, the voltage detecting unit 114′ determines that the voltage variation rate θ1 is smaller than the predetermined voltage variation rate (θp), and accordingly outputs the corresponding voltage detecting signal S_VD. Now, the control unit 120 determines that the electronic device 10 has a higher average output current/current output capability according to the voltage detecting signal S_VD. Conversely, when the voltage drop characteristic of the system voltage VDD corresponds to the line segment L2, the voltage detecting unit 114′ determines that the voltage variation rate θ2 is greater than the predetermined voltage variation rate (θp), and accordingly outputs the corresponding voltage detecting signal S_VD. Now, the control unit 120 determines that the electronic device 10 has a lower average output current/current output capability according to the voltage detecting signal S_VD. In other words, in the present embodiment, the voltage detecting unit 114′ indicates the voltage drop characteristic of the system voltage VDD by the voltage variation rate, and accordingly generates the voltage detecting signal S_VD, where the voltage variation rate is inversely proportional to the average output current/current output capability of the electronic device 10. Moreover, if the voltage detecting signal S_VD generated by the voltage detecting unit 114′ is a digit signal, the voltage detecting unit 114′ can be implemented by any component having an analog-to-digital conversion function.

It should be noticed that according to the aforementioned embodiments of FIG. 3A to FIG. 4B, those skilled in the art can deduce by themselves that by more than two different predetermined time or predetermined voltage variation rates can be set to define at least three voltage detecting signals S_VD corresponding to different average output currents/current output capabilities, so as to comply with the implementation of the embodiment of FIG. 2 that the peripheral apparatus 100 has at least three operation states.

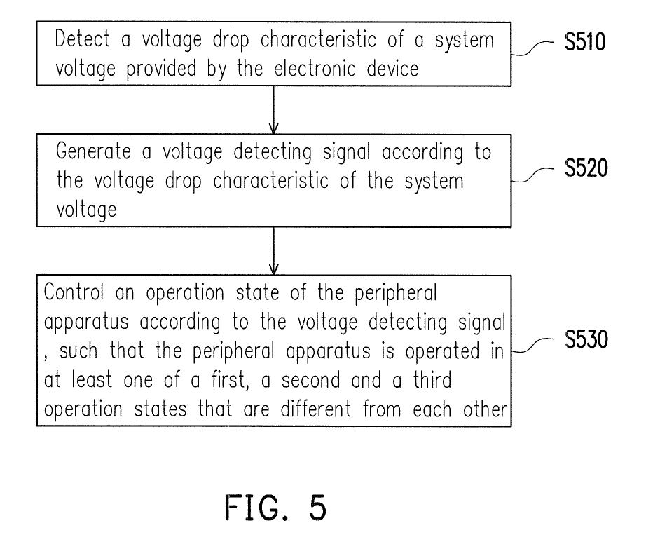

FIG. 5 is a flowchart illustrating a control method of a peripheral apparatus according to an embodiment of the invention. The control method of the present embodiment can be used to control the peripheral apparatus 100 of FIG. 1 to provide a peripheral function to the electronic device 10 for use. Referring to FIG. 5, first, a voltage drop characteristic of a system voltage provided by an electronic device is detected (step S510). A voltage detecting signal is generated according to the detected voltage drop characteristic of the system voltage (step S520). Then, an operation state of the peripheral apparatus is controlled according to the generated voltage detecting signal, such that the peripheral apparatus operates in at least one of a first, a second and a third operation states that are different from each other (step S530).

In an exemplary embodiment of the invention, the steps of detecting the voltage drop characteristic and generating the voltage detecting signal (the steps S520 and S520) can be implemented as follows. A voltage drop time required when the system voltage drops to a predetermined voltage value is calculated, where the voltage drop time indicates the voltage drop characteristic of the system voltage. The voltage detecting signal related to the voltage drop time is generated, where the voltage drop time is proportional to the average output current of the electronic device.

In another exemplary embodiment of the invention, the steps S510 and S520 can also be implemented as follows. A voltage variation rate of the system voltage within the predetermined period is calculated, where the voltage variation rate indicates the voltage drop characteristic of the system voltage. The voltage detecting signal related to the voltage variation rate is generated, where the voltage variation rate is inversely proportional to the average output current of the electronic device.

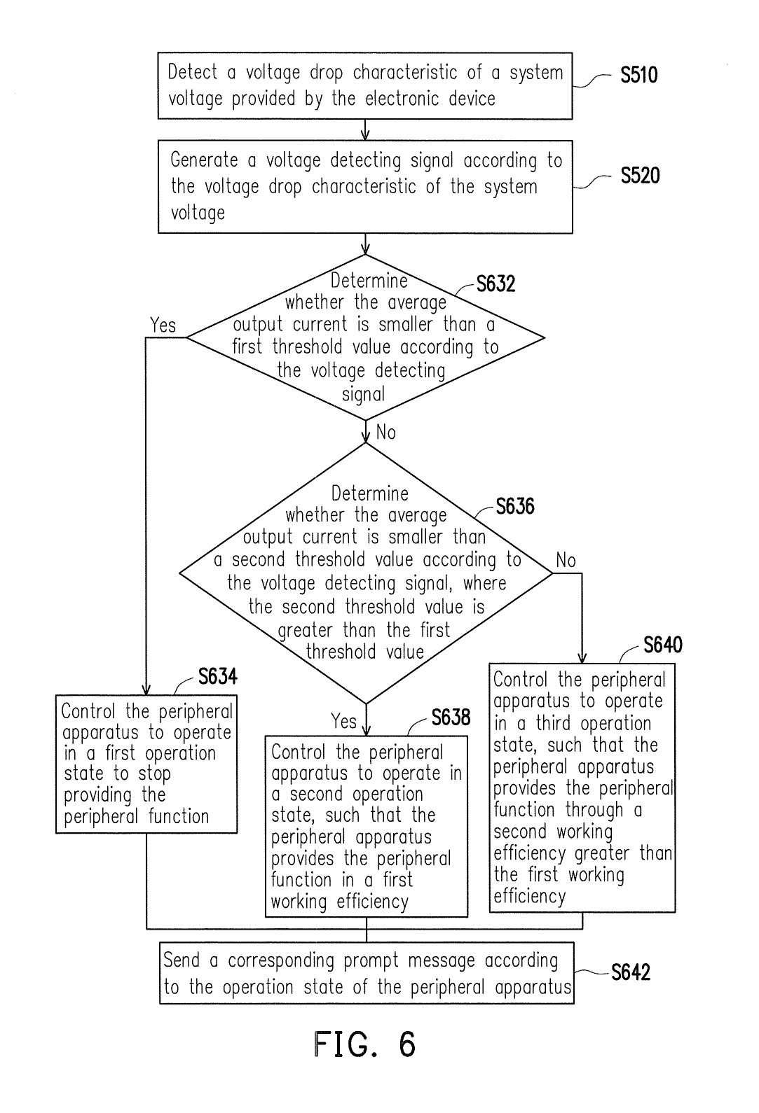

FIG. 6 is a flowchart illustrating a control method of a peripheral apparatus according to another embodiment of the invention. In the present embodiment, steps S632-S640 are used to implement the operation of controlling the operation state of the peripheral apparatus according to the voltage detecting signal.

Referring to FIG. 6, after the step of generating the voltage detecting signal (step S520), it is determined whether the average output current is smaller than a first threshold value according to the voltage detecting signal (step S632). If the determination result is affirmative, the peripheral apparatus is controlled to operate in a first operation state to stop providing the peripheral function (step S634). If the determination result is negative, it is determined whether the average output current is smaller than a second threshold value according to the voltage detecting signal, where the second threshold value is greater than the first threshold value (step S636). If the determination result of the step S636 is affirmative, the peripheral apparatus is controlled to operate in a second operation state, such that the peripheral apparatus provides the peripheral function in a first working efficiency (step S638). Conversely, if the determination result of the step S636 is negative, the peripheral apparatus is controlled to operate in a third operation state, such that the peripheral apparatus provides the peripheral function through a second working efficiency greater than the first working efficiency (step S640).

In the present embodiment, the control method further includes sending a corresponding prompt message according to the operation state of the peripheral apparatus after the operation state of the peripheral apparatus is set in collaboration with a hardware design of the peripheral apparatus (step S642), so as to prompt the user the current operation state of the peripheral apparatus.

Those skilled in the art can learn enough instructions and recommendations of the control methods of the peripheral apparatus of FIG. 5 and FIG. 6 from the related descriptions of the embodiments of FIG. 1 to FIG. 4B, so that detailed descriptions thereof are not repeated.

In summary, according to the peripheral apparatus and the control method thereof, the peripheral apparatus can detect the voltage drop characteristic of the system voltage provided by the electronic device to determine the magnitude of the average output current (i.e. a current output capability), and the peripheral apparatus can be operated in different operation states according to the current output capability, such that the peripheral apparatus has better power specification compatibility.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A peripheral apparatus, suitable for coupling an electronic device to provide a peripheral function to the electronic device for use, wherein the peripheral apparatus draws power supplies required for operation from the electronic device, the peripheral apparatus comprising:
a power detecting module, detecting a voltage drop characteristic of a system voltage provided by the electronic device, and generating a voltage detecting signal accordingly, wherein the voltage detecting signal is related to a magnitude of an average output current of the electronic device; and
a control unit, coupled to the power detecting module, and controlling an operation state of the peripheral apparatus according to the voltage detecting signal, such that the peripheral apparatus is operated in at least one of a first, a second and a third operation states that are different from each other.

2. The peripheral apparatus as claimed in claim 1, wherein the control unit determines whether the average output current is smaller than a first threshold value according to the voltage detecting signal, and controls the peripheral apparatus to operate in the first operation state to stop providing the peripheral function when the average output current is smaller than the first threshold value.

3. The peripheral apparatus as claimed in claim 2, wherein when the average output current is greater than or equal to the first threshold value, the control unit further determines whether the average output current is smaller than a second threshold value according to the voltage detecting signal, wherein the second threshold value is greater than the first threshold value; when the average output current is greater than or equal to the first threshold value and is smaller than the second threshold value, the control unit controls the peripheral apparatus to operate in the second operation state, such that the peripheral apparatus provides the peripheral function in a first working efficiency.

4. The peripheral apparatus as claimed in claim 3, wherein when the average output current is greater than or equal to the second threshold value, the control unit controls the peripheral apparatus to operate in a third operation state, such that the peripheral apparatus provides the peripheral function through a second working efficiency greater than the first working efficiency.

5. The peripheral apparatus as claimed in claim 1, wherein the power detecting module comprises:
a pre-loading unit, configured to provide a current path coupled to the system voltage, wherein the pre-loading unit is controlled by the control unit to determine whether or not to turn on the current path, such that the system voltage has a voltage drop in response to the turned-on current path; and
a voltage detecting unit, coupled to the pre-loading unit, and detecting the system voltage to determine the voltage drop characteristic of the system voltage according to a relative relationship between the generated voltage drop and time, so as to generate the voltage detecting signal accordingly.

6. The peripheral apparatus as claimed in claim 5, wherein the power detecting unit calculates a voltage drop time required when the system voltage drops to a predetermined voltage value, and indicates the voltage drop characteristic of the system voltage by the voltage drop time to generate the voltage detecting signal, wherein the voltage drop time is proportional to the average output current of the electronic device.

7. The peripheral apparatus as claimed in claim 5, wherein the voltage detecting unit calculates a voltage variation rate of the system voltage within a predetermined period, and indicates the voltage drop characteristic of the system voltage by the voltage variation rate to generate the voltage detecting signal, wherein the voltage variation rate is inversely proportional to the average output current of the electronic device.

8. The peripheral apparatus as claimed in claim 1, further comprising:
a prompt module, coupled to the control unit, configured to send a corresponding prompt message according to the operation state of the peripheral apparatus.

9. A control method of a peripheral apparatus, wherein the peripheral apparatus is suitable for coupling an electronic device to provide a peripheral function to the electronic device for use, wherein the peripheral apparatus draws power supplies required for operation from the electronic device, the control method of the peripheral apparatus comprising:
detecting a voltage drop characteristic of a system voltage provided by the electronic device;
generating a voltage detecting signal according to the voltage drop characteristic of the system voltage, wherein the voltage detecting signal is related to a magnitude of an average output current of the electronic device; and
controlling an operation state of the peripheral apparatus according to the voltage detecting signal, such that the peripheral apparatus is operated in at least one of a first, a second and a third operation states that are different from each other.

10. The control method of the peripheral apparatus as claimed in claim 9, further comprising:
calculating a voltage drop time required when the system voltage drops to a predetermined voltage value, and indicating the voltage drop characteristic of the system voltage by the voltage drop time; and
generating the voltage detecting signal related to the voltage drop time, wherein the voltage drop time is proportional to the average output current of the electronic device.

11. The control method of the peripheral apparatus as claimed in claim 9, further comprising:
calculating a voltage variation rate of the system voltage within a predetermined period, and indicating the voltage drop characteristic of the system voltage by the voltage variation rate; and
generating the voltage detecting signal related to the voltage variation rate, wherein the voltage variation rate is inversely proportional to the average output current of the electronic device.

12. The control method of the peripheral apparatus as claimed in claim 9, wherein the step of controlling the operation state of the peripheral apparatus according to the voltage detecting signal, such that the peripheral apparatus is operated in at least one of a first, a second and a third operation states that are different from each other comprises:
determining whether the average output current is smaller than a first threshold value according to the voltage detecting signal;
controlling the peripheral apparatus to operate in the first operation state to stop providing the peripheral function when the average output current is smaller than the first threshold value;
determining whether the average output current is smaller than a second threshold value when the average output current is greater than or equal to the first threshold value, wherein the second threshold value is greater than the first threshold value;
controlling the peripheral apparatus to operate in the second operation state when the average output current is greater than the first threshold value and is smaller than the second threshold value, such that the peripheral apparatus provides the peripheral function in a first working efficiency; and
controlling the peripheral apparatus to operate in a third operation state when the average output current is greater than or equal to the second threshold value, such that the peripheral apparatus provides the peripheral function through a second working efficiency greater than the first working efficiency.

13. The control method of the peripheral apparatus as claimed in claim 9, further comprising:
sending a corresponding prompt message according to the operation state of the peripheral apparatus.
